(19) United States
(12) Patent Application Publication
(10) Pub. No.: US 2024/0391340 A1
(43) Pub. Date: Nov. 28, 2024

(54) PRIORITIZING UTILITY PROGRAMS FOR OPEN VEHICLE GRID INTEGRATION PLATFORM

(71) Applicant: Honda Motor Co., Ltd., Tokyo (JP)

(72) Inventor: ROBERT M UYEKI, Torrance, CA (US)

(21) Appl. No.: 18/323,704

(22) Filed: May 25, 2023

(51) Int. Cl. B60L 53/62; B60L 53/66

(52) U.S. Cl. CPC B60L 53/62; B60L 53/665; B60L 2240/70

(57) ABSTRACT

A system and method for prioritizing utility programs for open vehicle grid integration platform is disclosed. The system receives, from a server, a proposal for an Electric Vehicle Original Equipment Manufacturer (EV-OEM) to participate in a utility program of an electric utility. The system determines statistical information that includes at least one of operational statistics associated with vehicles that are associated with the EV-OEM and require charging services of the electric utility, charging preferences of the users of the vehicles, and cost information associated with the utility program. Thereafter the system computes a metric that indicates a viability of the utility program for the EV-OEM based on contents of the proposal and the statistical information, and transmits, to the server, a message that includes an acceptance of the proposal or a rejection of the proposal based on whether the metric is above a threshold.

### BACKGROUND

With the growing popularity of electric vehicles (EVs), utilities are seeking for better ways to manage their energy supplies. Demand response programs are one strategy that is gaining traction. These programs encourage EV owners to limit their energy use during peak demand periods, alleviating the pressure on the grid. Participating in demand response programs, however, might be a difficult option for Original Equipment Manufacturers (OEMs) who create EVs. OEMs are concerned about the impact of these programs on their car charging schedules and overall EV dependability. Furthermore, OEMs may lack access to enough information to make an educated decision about whether or not to join, resulting in missed potential for cost savings and decreased environmental impact. There is currently no clear system in place to assist EV OEMs in making educated judgements about participating in demand response programs. As a result, people may be unwilling to participate and so miss out on possible benefits.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a system for prioritizing utility programs for open vehicle grid integration platform is disclosed. The system may include circuitry that receives, from a server, a proposal for an Electric Vehicle Original Equipment Manufacturer (EV-OEM) to participate in a utility program of an electric utility. The system may determine statistical information that includes at least one of operational statistics associated with vehicles that are associated with the EV-OEM and that require charging services of the electric utility, charging preferences of the users of the vehicles, and cost information associated with the utility program. Thereafter, the system may compute a metric that indicates a viability of the utility program for the EV-OEM based on contents of the proposal and the statistical information, and may transmit, to the server, a message that includes an acceptance of the proposal or a rejection of the proposal based on whether the metric is above a threshold.

According to another embodiment of the disclosure, a method for prioritizing utility programs for open vehicle grid integration platform is disclosed. The method may include receiving, from a server, a proposal for an Electric Vehicle Original Equipment Manufacturer (EV-OEM) to participate in a utility program of an electric utility. The method may further include determining statistical information that includes at least one of operational statistics associated with vehicles that are associated with the EV-OEM and that require charging services of the electric utility, charging preferences of the users of the vehicles, and cost information associated with the utility program. Thereafter the method may include computing a metric that indicates a viability of the utility program for the EV-OEM based on contents of the proposal and the statistical information, and transmitting, to the server, a message that includes an acceptance of the proposal or a rejection of the proposal based on whether the metric is above a threshold.

According to another embodiment of the disclosure, a non-transitory computer-readable medium is provided. The non-transitory computer-readable medium may have stored thereon computer implemented instructions that, when executed by a system, causes the system to execute operations. The operations may include receiving, from a server, a proposal for an Electric Vehicle Original Equipment Manufacturer (EV-OEM) to participate in a utility program of an electric utility. The operations may further include determining statistical information that includes at least one of operational statistics associated with vehicles that are associated with the EV-OEM and that require charging services of the electric utility, charging preferences of the users of the vehicles, and cost information associated with the utility program. Thereafter the operations may include computing a metric that indicates a viability of the utility program for the EV-OEM based on contents of the proposal and the statistical information, and transmitting, to the server, a message that includes an acceptance of the proposal or a rejection of the proposal based on whether the metric is above a threshold.

### BRIEF DESCRIPTION OF THE DRAWINGS

FIG. 1 is a block diagram that illustrates an exemplary network environment for prioritizing utility programs for open vehicle grid integration platform, in accordance with an embodiment of the disclosure.

FIG. 2 is a block diagram that illustrates a system for prioritizing utility programs for open vehicle grid integration platform, in accordance with an embodiment of the disclosure.

FIG. 3 is a diagram that illustrates an exemplary sequence of operations for prioritizing utility programs for open vehicle grid integration platform, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in the disclosed system and method for prioritizing utility programs for open vehicle grid integration platform (OVGIP). Exemplary aspects of the disclosure may provide a system which may receive, from a server, a proposal for an Electric Vehicle Original Equipment Manufacturer (EV-OEM) to participate in a utility program of an electric utility. The system may determine statistical information that includes at least one of operational statistics associated with vehicles that may be associated with the EV-OEM and require charging services of the electric utility, charging preferences of the users of the vehicles, and cost information associated with the utility program. Thereafter, the system may compute a metric that indicates a viability of the utility program for the EV-OEM based on contents of the proposal and the statistical information, and may transmit, to the server, a message that includes an acceptance of the proposal or a rejection of the proposal based on whether the metric is above a threshold.

Vehicles such as Plug-in Electric Vehicles (PEVs) may be integrated as a resource for grid dependability using OVGIP. OVGIP offers a framework for open technologies that enables the integration of EV demand flexibility as a grid resource. This may make it possible to time EV charging with renewable energy production, supporting the idea of a grid that is carbon neutral. OVGIP may also create a centralized, secure communications network for EVs and associated users. This exchange may help utilities to forecast the needs for distribution capacity and reliability by providing them a visibility into and understanding of EV charging behavior. The OVGIP may increase dependability and lower the cost of utility infrastructure by enabling EV participation in utility energy management, energy efficiency, and load management programs.

Electric utility companies may run utility programs in collaboration with Original Equipment Manufacturers of EVs. Such programs may include features such as time-of-use pricing, peak load reduction, demand charge mitigation, load balancing for intermittent solar and wind generation, Real Time Pricing (RTP), aggregated Demand Response (DR), and scheduling dispatch for ancillary services. Such programs may require the users to responsibly manage charging of the vehicles as per a schedule in exchange for incentives from the electric utility. The OEMs for such vehicles may be incentivized with incentive schemes to promote such utility programs in particular service territories.

The present disclosure offers a new approach that provides EV-OEMs with necessary information to make an informed decision about participation in demand response programs offered by the electric utilities. This may involve computing metrics that measure ROI for different utility programs and insights into a potential impact on vehicle charging schedules and overall reliability, as well as the potential cost savings for both the users and EV-OEM, and environmental benefits. With suitable information, the EV-OEM may be able to make a more informed decision about whether to participate in a utility program and contribute to a more efficient and sustainable energy system.

Reference will now be made in detail to specific aspects or features, examples of which are illustrated in the accompanying drawings. Wherever possible, corresponding, or similar reference numbers will be used throughout the drawings to refer to the same or corresponding parts.

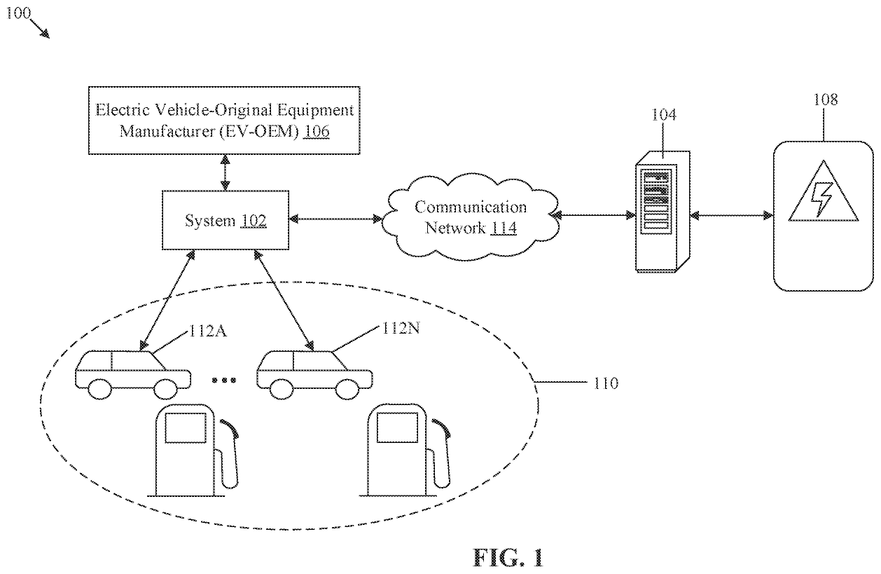

FIG. 1 is a block diagram that illustrates an exemplary network environment for prioritizing utility programs for an open vehicle grid integration platform, in accordance with an embodiment of the disclosure. With reference to FIG. 1, there is shown a network environment 100. The network environment 100 may include a system 102, a server 104, an Electric Vehicle Original Equipment Manufacturer (EV-OEM) 106, and an electric utility 108. There is further shown a service territory 110 associated with the electric utility 108 and vehicles 112A . . . 112N that require charging services within the service territory 110. The system 102, the server 104, and other devices in the network environment 100 may communicate with each other via a communication network 114.

The system 102 may include suitable logic, circuitry, interfaces, and/or code that may be configured to process proposals associated with utility programs on behalf of the EV-OEM 106. Additionally, the system 102 may be responsible for execution of contracts, commissioning or decommissioning of EV resources, receipt, or payments of incentives to individual EV-OEMs and/or EV users. In accordance with an embodiment, the system 102 may be associated with the EV-OEM 106 or an entity that may be an intermediary between the electric utilities and multiple EV-OEMs. Examples of the system 102 may include, but are not limited to, a server, a datacenter with a network of servers, a distributed computing system, a distributed ledger network, a workstation, a network device, or an edge device.

The server 104 may include suitable logic, circuitry, and interfaces, and/or code that may be configured to send the proposals to the system 102 on behalf of the electric utility 108 or the entity that may be an intermediary between the electric utilities and multiple EV-OEMs. The server 104 may communicate with the system 102 and the vehicles 112A . . . 112N in the service territory 110 via messages or application programming interface (API) calls. Additionally, the server 104 may be responsible for parsing and processing responses received from the system 102 towards the proposals. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the system 102 as two separate entities. In certain embodiments, the functionalities of the server 104 may be incorporated in its entirety or at least partially in the system 102, without a departure from the scope of the disclosure.

An OEM is a business that creates, produces, and markets goods or parts that are incorporated into the finished goods of other businesses. The EV-OEM 106 may be referred to as a business that specializes in designing and producing electric vehicles (EVs) or components in the context of EVs. The EV-OEM 106 may manufacture finished EVs or certain parts like batteries, motors, power electronics, charging systems, and other elements required for the functioning of the EVs.

The electric utility 108 may be an established entity that may be responsible for at least one of generation, distribution, or supply of electrical power to residential, commercial, or industrial consumers.

The service territory 110 may be defined as a geographic area or region that the electric utility 108 is permitted to serve. This may include precise geographical limits within which the electric utility 108 may service customers and provide power. Depending on a size of the electric utility 108, the service territory 110 may be determined by regulatory agencies and may include one or more blocks, a geofenced area, an entire city, a county, a state, or even multiple states.

Each of the vehicles 112A . . . 112N may be a non-autonomous electric vehicle, a semi-autonomous electric vehicle, or a fully autonomous EV, for example, as defined by National Highway Traffic Safety Administration (NHTSA) or Society of Automotive Engineers (SAE) automation levels. Examples of the EV may include, but are not limited to, a e-kick scooter, a personal transporter, an electric scooter, a four-wheeler vehicle, a three-wheeler vehicle, a two-wheeler vehicle, a wheelchair with an actuator-based driving unit, or a hybrid vehicle. Examples of the four-wheeler vehicle may include, but are not limited to, a Battery Electric Vehicle (BEV) and a Plug-in Hybrid Electric Vehicle (PHEV).

The communication network 114 may include a communication medium through which the system 102, the server 104, the vehicles 112A . . . 112N, and other electronic devices in the network environment 100 may communicate with each other. The communication network 114 may include one of a wired connection or a wireless connection. Examples of the communication network 114 may include, but are not limited to, the Internet, a cloud network, a Cellular or Wireless Mobile Network (such as a Long-Term Evolution and 5G New Radio), a Wireless Fidelity (Wi-Fi) network, a Personal Area Network (PAN), a Local Area Network (LAN), or a Metropolitan Area Network (MAN).

Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

During operation, the system 102 may receive, from the server 104, a proposal to participate in a utility program of the electric utility 108. Each utility program may be offered by an electric utility (such as the electric utility 108) to multiple EV-OEMs that may have a number of vehicles in the service territory of the electric utility 108. For EV OEMs, the utility program may correspond to a collection of initiatives, alliances, and incentives provided by the electric utility 108 to work with the EV-OEMs and encourage an integration of such vehicles into the grid. The utility program may forge a partnership between the electric utility 108 and the EV-OEMs to provide an integrated suite of automated EV charge management control strategies including, but not limited to, time-of-use (TOU) pricing, peak load reduction, demand charge mitigation, load balancing for intermittent solar/wind generation, Real Time Pricing (RTP), aggregated Demand Response (DR), and scheduling dispatch for ancillary services. The program may provide the ability for EV customers (i.e., users) to control charging, reduce costs, and participate in energy savings incentive programs.

The received proposal may be for the EV-OEM 106 that may have the vehicles 112A . . . 112N in the service territory 110 of the electric utility 108. The proposal may be one of an electronic document, an electronic contract, or an electronic message that includes contents of the proposal in a structured format or a semi-structured format. For example, the proposal may be a Portable Document Format (PDF) file, a JavaScript Object Notation (JSON) file, an extensible Markup Language (XML) file, and the like.

After receiving the proposal, the system 102 may assess whether it is viable for the EV-OEM 106 to accept the proposal and follow terms/conditions stated in the proposal to meet requirements of the utility program in the service territory 110. The assessment may be needed as the EV-OEM 106 may need to spend on different programs including, but not limited to, marketing campaigns to onboard customers in the utility program that own and/or operate the vehicles 112A . . . 112N in the service territory 110. For example, if the service territory 110 includes very few vehicles of a particular EV-OEM, it may not be financially viable for that particular EV-OEM to accept the proposal for the service territory 110.

As part of the assessment, the system 102 may determine statistical information that may include at least one of operational statistics associated with the vehicles 112A . . . 112N that may be associated with the EV-OEM 106 and require charging services of the electric utility 108. The statistical information may further include charging preferences of the users of the vehicles 112A . . . 112N, cost information associated with the utility program, and the like. Thereafter, the system 102 may compute a metric based on contents of the proposal and the statistical information. The metric may indicate a viability of the utility program for the EV-OEM 106. For example, the metric may be a return on investment (ROI) metric that may be computed based on a net return associated with incentives offered in the proposal and a net cost that the EV-OEM 106 is likely to incur for participating in the utility program. Alternatively, the metric may be a benefit-cost ratio (BCR) between incentives offered in the proposal and a net cost that the EV-OEM 106 is likely to incur for participating in the utility program.

Based on whether the metric is above a threshold, the system 102 may transmit, to the server 104, a message that includes an acceptance of the proposal or a rejection of the proposal. For example, if the metric is above the threshold, the proposal may be accepted. If the metric is below the threshold, then the proposal may be rejected, or a renegotiation process may be initiated to modify terms or conditions in the proposal. In at least one embodiment, machine learning model(s) may be utilized to provide a recommendation on whether to accept the proposal or reject the proposal based on historical data on past proposals and past statistical information for the same or different service territory.

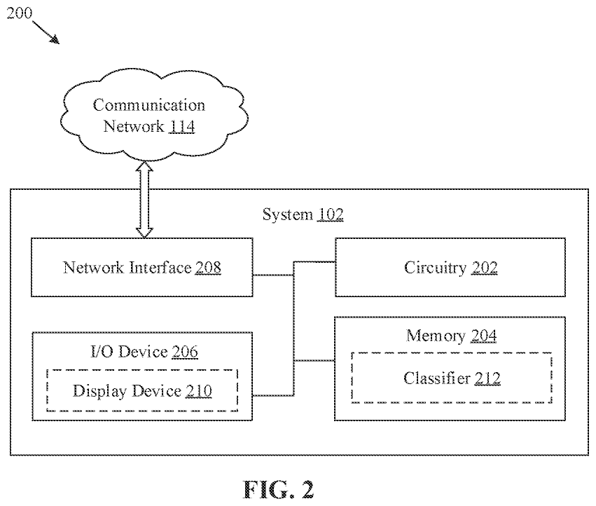

FIG. 2 is a block diagram that illustrates an exemplary system of FIG. 1, in accordance with an embodiment of the disclosure. FIG. 2 is explained in conjunction with elements from FIG. 1. With reference to FIG. 2, there is shown a block diagram 200 of the system 102. The system 102 may include circuitry 202, a memory 204, an input/output (I/O) device 206, and a network interface 208. In at least one embodiment, the I/O device 206 may include a display device 210. The memory 204 may store a classifier 212. The circuitry 202 may be communicatively coupled with the memory 204, the I/O device 206, and the network interface 208 through an I/O interface (not shown).

A person of ordinary skill in the art will understand that the block diagram 200 of the system 102 may also include other suitable components or systems, in addition to the components or systems which are illustrated herein to describe and explain the function and operation of the present disclosure. Detailed description of such components or systems has been omitted from the disclosure for the sake of brevity.

The circuitry 202 may include suitable logic, circuitry, and/or interfaces code that may be configured to execute program instructions associated with different operations to be executed by the system 102. The circuitry 202 may include any suitable special-purpose or general-purpose computer, computing entity, or processing device including various computer hardware or software modules and may be configured to execute instructions stored on any applicable computer-readable storage media. For example, the circuitry 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry 202 may include any number of processors configured to, individually or collectively, perform or direct performance of any number of operations of the display device 210, as described in the present disclosure. Examples of the processor may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the program instructions executable by the circuitry 202. In at least one embodiment, the memory 204 may be further configured to store the classifier 212 (i.e., a pretrained Machine Learning (ML) model). Example implementations of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include one or more input and output devices that may communicate with different components of the system 102. For example, the I/O device 206 may receive user inputs to trigger execution of program instructions associated with different operations to be executed by the display device 210. Examples of the I/O device 206 may include, but are not limited to, a touch screen, a keyboard, a mouse, a joystick, a microphone, a display device, and a speaker.

The network interface 208 may include suitable logic, circuitry, and interfaces that may be configured to facilitate communication between the system 102 and the server 104 via the communication network 114. The network interface 208 may be implemented by use of various known technologies to support wired or wireless communication of the system 102 with the communication network 114. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

The display device 210 may include suitable logic, circuitry, and interfaces that may be configured to display the content of the proposal, the statistical information, and a decision to accept, reject, or renegotiate terms/conditions of the proposal. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices.

The classifier 212 may be an ML model that may be trained on historical data to classify whether a proposal for a utility program should be accepted, rejected, or renegotiated. For an unseen proposal (i.e., at an inference stage), an output of the classifier 212 may be treated as a recommendation for the system 102. The accuracy of the recommendation may depend on the data the classifier 212 is trained on.

In accordance with an embodiment, the classifier 212 may be an ML model that may be not based on neural networks. Example implementations of the classifier 212 may include, but are not limited to, a Support Vector Machine (SVM) classifier, a Logistic classifier, a Naïve Bayes classifier, a Random Forest classifier, a Decision Tree classifier, or a k-Nearest Neighbor classifier.

In accordance with an embodiment, the classifier 212 may be a neural network model that may be a computational network or a system of artificial neurons, which may be arranged in a plurality of layers. The plurality of layers of the neural network model may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model. Outputs of each hidden layer may be coupled to inputs of at least one node in other layers of the neural network model. Node(s) in the final layer may receive inputs from at least one hidden layer to output a result. The number of layers and the number of nodes in each layer may be determined from hyper-parameters of the neural network model. Such hyper-parameters may be set before or after training the neural network model on a training dataset.

Each node of the neural network model may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to the same mathematical function or a different mathematical function.

In training of the neural network model, one or more parameters of each node of the neural network may be updated based on whether an output of the final layer for a given input (from the training dataset) matches a correct result based on a loss function for the neural network model. The above process may be repeated for same or a different input until a minima of a loss function is achieved, and a training error is minimized. Several methods for training are known in art, for example, gradient descent, stochastic gradient descent, batch gradient descent, gradient boost, meta-heuristics, and the like.

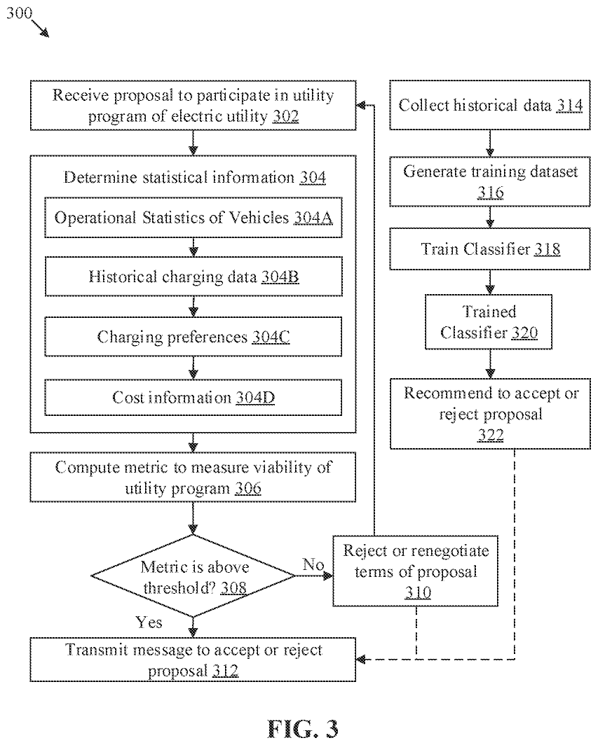

The classifier 212 may include electronic data, which may be implemented as, for example, a software component of an application executable on an electronic device (for example, the system 102). The classifier 212 may rely on libraries, external scripts, or other logic/instructions for execution by a processing device, such as the circuitry 202. The classifier 212 may include code and routines configured to enable a computing device to generate a recommendation. Additionally, or alternatively, the classifier 212 may be implemented using hardware including a processor, a microprocessor (e.g., to perform or control performance of one or more operations), a field-programmable gate array (FPGA), or an application-specific integrated circuit (ASIC). Alternatively, in some embodiments, the classifier 212 may be implemented using a combination of hardware and software. Various operations of the circuitry 202 are described further, for example, in FIG. 3.

FIG. 3 is a flowchart that illustrates an exemplary sequence of operations for prioritizing utility programs for open vehicle grid integration platform, in accordance with an embodiment of the disclosure. With reference to FIG. 3, there is shown a flowchart 300. The elements of the flowchart 300 are described in conjunction with elements of FIGS. 1 and 2. The operations from 302 to 322 may be implemented, for example, by the system 102 of FIG. 1 or the circuitry 202 of FIG. 2. The operations of the flowchart 300 may start at 302.

At 302, a proposal may be received for the EV-OEM 106 to participate in a utility program of the electric utility 108. In accordance with an embodiment, the system 102 may receive the proposal from the server 104. The proposal may be one of an electronic document, an electronic contract, or an electronic message that includes the contents of the proposal in a structured format or a semi-structured format. The contents may specify details including terms and/or conditions of the utility program that the EV-OEM 106 and associated vehicles (i.e., the vehicles 112A . . . 112N) must adhere to if the proposal is accepted.

In accordance with an embodiment, the contents of the proposal may include at least one of a service territory of the electric utility 108, a set of conditions that may be related to a demand response management and charging requirements of the vehicles 112A . . . 112N, a type of charging technology that may be included in the utility program, incentives for the EV-OEM 106 and the users of the vehicles 112A . . . 112N, and a duration of the utility program. Example contents of the proposal are provided in Table 1, as follows:

TABLE 1
Example Contents of the Proposal

| Category | Value |
|---|---|
| Service Territory | San Francisco, CA/94016 |
| Duration of Program | 1 Year |
| Type of Charging Technology | V1G |
| Charging Duration | 4-7 PM |
| Peak Load Shedding Opportunity | 8-10 PM |
| Utility to EV Consumer Incentives (USD) | 150 USD per vehicle for |
| | enrollment, |
| | 5 USD per charge event, |
| | 20 USD for load shedding in peak |
| | hours, |
| | 1 USD for off-peak charging |
| Utility to EV-OEM Incentives (USD) | . . . |
| . . . | . . . |

In Table 1, the incentives are divided into Utility to EV consumer incentives (in USD) for different categories of charging and Utility to EV-OEM incentives (in USD).

At 304, statistical information may be determined. In order to determine whether it is financially viable for the EV-OEM 106 to accept the proposal and implement the utility program in the service territory 110, an assessment may be required. As part of the assessment, the system 102 may determine the statistical information that may include at least one of operational statistics 304A associated with the vehicles 112A . . . 112N that may be associated with the EV-OEM 106 and that require charging services of the electric utility 108. The statistical information may also include charging preferences 304C of the users of the vehicles 112A . . . 112N, and cost information 304D associated with the utility program. For example, the cost information may include at least one of a marketing cost that the EV-OEM 106 is likely to incur over a duration of the utility program, an IT cost that the EV-OEM 106 is likely to incur over the duration of the utility program, and/or a recruitment cost that the EV-OEM 106 is likely to incur over the duration of the utility program.

In accordance with an embodiment, the operational statistics 304A may include at least one of a first count of the vehicles 112A . . . 112N that require the charging services, a second count of vehicles associated with an EV-OEM that may be different (e.g., competitor OEMs) from the EV-OEM 106, a percentage attrition of the users of the vehicles 112A . . . 112N over a period, a total battery capacity of the vehicles 112A . . . 112N, or a set of charging features offered in the vehicles 112A . . . 112N. For example, the operational statistics 304A may include a potential market size of 100 EVs and 250 PHEVs, an average battery size of 40 kWh, a recruitment cost of 100 USD/EV and 50 USD/kWh to onboard the users in the utility program, an attrition (%) of 12%, and Information Technology (IT) cost of about 10,000 USD per month. The statistics 304A may be helpful to assess the viability (e.g., ROI) of the utility program with a minimum quantity of EVs and PHEVs associated with the EV-OEM 106 in the service territory 110.

In accordance with an embodiment, the statistical information may further include historical charging data 304B for each of the vehicles 112A . . . 112N. By way of example, and not limitation, the historical charging data 304B may include at least one of seasonal information, a time of a charging request, a minimum state of charge, a target state of charge, and a charging location. An example of the historical charging data 304B (includes the charging preferences) is provided in Table 2, as follows:

TABLE 2
Example of the historical charging data 304B

| | |
|---|---|
| Season | Summer |
| Time | 4:32 PM |
| EV SOC | 75% |
| Location | Lat/Lon* |
| Charge Level | L2 |
| Departure time | 7 AM |
| Plugged in/V2G capable | Yes/Yes |
| Target SOC | 100% |
| Min SOC | 50% |
| EV quantity | 100 EV, 250 PHEV |
| Battery | 500 kW |

In accordance with an embodiment, the statistical information may further include future sales data for the EV-OEM 106. The future sales data may include at least one of a first projection on an increase in the first count in a defined period from a time of the acceptance of the proposal, a second projection on an increase in the total battery capacity over the defined period, or a third projection on a total ROI over the defined period due to the incentives. An example of charging data (includes the charging preferences) based on the future sales data is provided in Table 3, as follows:

TABLE 3
Example of the charging data based on future sales data

| | |
|---|---|
| Season | Summer |
| Time | 4:32 PM |
| EV SOC | 75% |
| Location | Lat/Lon* |
| Charge Level | L2 |
| Departure time | 7 AM |
| Plugged in/V2G capable | Yes/yes |
| Target SOC | 100% |
| Min SOC | 50% |
| EV quantity | 1000 EV, 5000 PHEV |
| Battery | 500 kW |

At 306, a metric may be computed based on contents of the proposal and the statistical information. In accordance with an embodiment, the system 102 may compute the metric based on the contents of the proposal and the statistical information. The metric may indicate a viability of the utility program for the EV-OEM 106. As an example, the metric may be a ROI metric that may be computed based on a net return associated with incentives offered in the proposal and a net cost that the EV-OEM 106 is likely to incur for participating in the utility program. As another example, the metric may be a BCR value between incentives offered in the proposal and a net cost that the EV-OEM 106 is likely to incur for participating in the utility program.

At 308, it may be determined whether the metric is above a threshold. In accordance with an embodiment, the system 102 may determine whether the metric is above the threshold. The determination may be performed to assess whether a minimum ROI or a minimum BCR is achievable if the EV-OEM 106 decides to participate in the utility program. If the metric is below the threshold (e.g., 10% ROI or a BCR of 1.0), then the control may pass to 310. Otherwise, the control may pass to 312.

At 310, the proposal may be rejected or renegotiated if the metric is below the threshold. The system 102 may reject the proposal or may initiate a process to renegotiate terms/conditions of the proposal with the server 104. In case of renegotiation, the control may pass to 302. During the process, operations from 302 to 310 may be performed for a number of iterations. If, after such iterations, the metric is still below the threshold, then the proposal may be rejected, and control may pass to 312.

At 312, a message may be transmitted to the server 104. In accordance with an embodiment, the system 102 may transmit, to the server 104, the message that may include an acceptance of the proposal or a rejection of the proposal based on whether the metric is above the threshold. Based on the message, the server 104 may transmit information that may indicate the acceptance of the proposal to a server associated with the electric utility 108 or the OVGIP platform.

At 314, historical data may be collected. In accordance with an embodiment, the system 102 may collect the historical data that includes past proposals that may have been accepted or rejected by the EV-OEM 106 or the system 102 in the past, past statistical information corresponding to each of the past proposals, and past messages that may include acceptances and rejections of the EV-OEM 106 for the past proposals.

At 316, a training dataset may be generated based on the historical data. The system 102 may generate the training dataset for the classifier 212 based on the historical data. The training dataset may include, for example, terms/conditions of the past proposals and past statistical information corresponding to such proposals, and corresponding labels (i.e., a prediction target) to indicate whether such proposals are acceptable.

At 318, the classifier 212 may be trained based on the training dataset. The system 102 may train the classifier 212 or may finetune a pretrained classifier to obtain a trained classifier 320 that may be configured to predict whether a proposal should be accepted or rejected based on the content of the proposal and the statistical information.

At 322, a recommendation may be generated. For the recommendation, the system 102 may prepare an input for the classifier 212 based on the contents of the proposal (received at 302). For example, the input may include contents of the proposal as sentence tokens or sentence vectors that may be input to the classifier 212. The input may be fed to the trained classifier 320 and the system 102 may generate a recommendation that may include whether to accept or reject the proposal based on an output of the trained classifier 320 for the input. The message (at 312) may be transmitted based on the recommendation.

Although the flowchart 300 is illustrated as discrete operations, such as 302, 304, 306, 308, 310, 312, 314, 316, 318, and 322, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as the system 102). The set of instructions may be executable by the machine and/or the computer to perform operations that may include receiving, from a server, a proposal for an Electric Vehicle Original Equipment Manufacturer (EV-OEM) to participate in a utility program of an electric utility. The operations may further include determining statistical information that includes at least one of operational statistics associated with vehicles that are associated with the EV-OEM and that require charging services of the electric utility, charging preferences of the users of the vehicles, and cost information associated with the utility program. Thereafter the operations may include computing a metric that indicates a viability of the utility program for the EV-OEM based on contents of the proposal and the statistical information, and transmitting, to the server, a message that includes an acceptance of the proposal or a rejection of the proposal based on whether the metric is above a threshold.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. A system, comprising:
circuitry that:
receives, from a server, a proposal for an Electric Vehicle Original Equipment Manufacturer (EV-OEM) to participate in a utility program of an electric utility;
determines statistical information that includes at least one of:
operational statistics associated with vehicles that are associated with the EV-OEM and that require charging services of the electric utility,
charging preferences of the users of the vehicles, and
cost information associated with the utility program;
computes a metric based on contents of the proposal and the statistical information, wherein the metric indicates a viability of the utility program for the EV-OEM; and
transmits, to the server, a message that includes an acceptance of the proposal or a rejection of the proposal based on whether the metric is above a threshold.

2. The system according to claim 1, wherein the proposal is one of an electronic document, an electronic contract, or an electronic message that includes the contents of the proposal in a structured format or a semi-structured format.

3. The system according to claim 1, wherein the contents of the proposal include at least one of:
a service territory of the electric utility,
a set of conditions that is related to a demand response management and charging requirements of the vehicles,
a type of charging technology that is included in the utility program,
incentives for the EV-OEM and users of the vehicles, or
a duration of the utility program.

4. The system according to claim 3, wherein the operational statistics include at least one of:
a first count of the vehicles that require the charging services,
a second count of vehicles associated with an EV-OEM that is different from the EV-OEM,
a percentage attrition of the users of the vehicles over a period,
a total battery capacity of the vehicles, or
a set of charging features offered in the vehicles.

5. The system according to claim 3, wherein the statistical information further includes historical charging data for each of the vehicles, and
the historical charging data includes at least one of seasonal information, a time of a charging request, a minimum state of charge, a target state of charge, a charging location.

6. The system according to claim 3, wherein the statistical information further includes future sales data for the EV-OEM, and the future sales data includes at least one of:
a first projection on an increase in the first count in a defined period from a time of the acceptance of the proposal,
a second projection on an increase in the total battery capacity over the defined period, or
a third projection on a total return on investment (ROI) over the defined period due to the incentives.

7. The system according to claim 1, wherein the cost information includes at least one of:
a marketing cost that the EV-OEM is likely to incur over a duration of the utility program,
an Information Technology (IT) cost that the EV-OEM is likely to incur over the duration of the utility program, or
a recruitment cost that the EV-OEM is likely to incur over the duration of the utility program.

8. The system according to claim 1, wherein the metric is a return on investment (ROI) metric that is computed based on a net return associated with incentives offered in the proposal and a net cost that the EV-OEM is likely to incur for participating in the utility program.

9. The system according to claim 1, wherein the metric is a benefit-cost ratio (BCR) between incentives offered in the proposal and a net cost that the EV-OEM is likely to incur for participating in the utility program.

10. The system according to claim 1, wherein the server, based on the message, transmits information that indicates the acceptance of the proposal to a server associated with the electric utility or an Open Vehicle Grid Integration Platform (OVGIP) platform.

11. The system according to claim 1, wherein the circuitry further:
collects historical data that includes:
past proposals that are accepted or rejected by the EV-OEM,
past statistical information corresponding to each of the past proposals, and
past messages that include acceptances and rejections of the EV-OEM for the past proposals;
generates a training dataset for a classifier based on the historical data;
trains the classifier based on the training dataset; and
prepares an input for the classifier based on the contents of the proposal;
feeds the input to the trained classifier; and
generates a recommendation that includes whether to accept or reject the proposal based on an output of the trained classifier for the input, wherein the message is transmitted based on the recommendation.

12. A method, comprising:
receiving, from a server, a proposal for an Electric Vehicle Original Equipment Manufacturer (EV-OEM) to participate in a utility program of an electric utility;
determining statistical information that includes at least one of:
operational statistics associated with vehicles that are associated with the EV-OEM and that require charging services of the electric utility,
charging preferences of the users of the vehicles, and
cost information associated with the utility program;
computing a metric based on contents of the proposal and the statistical information, wherein the metric indicates a viability of the utility program for the EV-OEM; and
transmitting, to the server, a message that includes an acceptance of the proposal or a rejection of the proposal based on whether the metric is above a threshold.

13. The method according to claim 12, wherein the contents of the proposal include at least one of:
a service territory of the electric utility,
a set of conditions that is related to a demand response management and charging requirements of the vehicles,
a type of charging technology that is included in the utility program,
incentives for the EV-OEM and users of the vehicles, or
a duration of the utility program.

14. The method according to claim 13, wherein the operational statistics include at least one of:
a first count of the vehicles that require the charging services,
a second count of vehicles associated with an EV-OEM that is different from the EV-OEM,
a percentage attrition of the users of the vehicles over a period,
a total battery capacity of the vehicles, or
a set of charging features offered in the vehicles.

15. The method according to claim 13, wherein the statistical information further includes historical charging data for each of the vehicles, and
the historical charging data includes at least one of seasonal information, a time of a charging request, a minimum state of charge, a target state of charge, a charging location.

16. The method according to claim 12, wherein the metric is a return on investment (ROI) metric that is computed based on a net return associated with incentives offered in the proposal and a net cost that the EV-OEM is likely to incur for participating in the utility program.

17. The method according to claim 12, wherein the metric is a benefit-cost ratio (BCR) between incentives offered in the proposal and a net cost that the EV-OEM is likely to incur for participating in the utility program.

18. The method according to claim 12, further comprising transmitting, by the server, information that indicates the acceptance of the proposal to a server associated with the first electric utility or an Open Vehicle Grid Integration Platform (OVGIP) server, wherein the information is transmitted based on the message.

19. The method according to claim 12, further comprising:
collecting historical data that includes:
past proposals that are accepted or rejected by the EV-OEM,
past statistical information corresponding to each of the past proposals, and
past messages that include acceptances and rejections of the EV-OEM for the past proposals;
generating a training dataset for a classifier based on the historical data;
training the classifier based on the training dataset; and
preparing an input for the classifier based on the contents of the proposal;
feeding the input to the trained classifier; and
generating a recommendation that includes whether to accept or reject the proposal based on an output of the trained classifier for the input, wherein the message is transmitted based on the recommendation.

20. A non-transitory computer-readable medium having stored thereon, computer-executable instructions which, when executed by a system, cause the system to execute operations, the operations comprising:
receiving, from a server, a proposal for an Electric Vehicle Original Equipment Manufacturer (EV-OEM) to participate in a utility program of an electric utility;
determining statistical information that includes at least one of:
operational statistics associated with vehicles that are associated with the EV-OEM and that require charging services of the electric utility,
charging preferences of the users of the vehicles, and
cost information associated with the utility program;
computing a metric based on contents of the proposal and the statistical information, wherein the metric indicates a viability of the utility program for the EV-OEM; and
transmitting, to the server, a message that includes an acceptance of the proposal or a rejection of the proposal based on whether the metric is above a threshold.
